(19) United States
(12) Patent Application Publication
(10) Pub. No.: US 2023/0404068 A1
(43) Pub. Date: Dec. 21, 2023

(54) METHODS AND DEVICES FOR THERMAL STABILIZATION ON PERISHABLE BIOLOGICAL SPECIMENS

(71) Applicant: Laboratory Corporation of America Holdings, Burlington, NC (US)

(72) Inventors: Ulrich Schaff, Livermore, CA (US); Mitchell Peevler, Walnut Creek, CA (US); Jason Ragar, Pittsburg, CA (US)

(21) Appl. No.: 18/336,765

(22) Filed: Jun. 16, 2023

Related U.S. Application Data
(60) Provisional application No. 63/353,299, filed on Jun. 17, 2022.

(51) Int. Cl. A01N 1/02

(52) U.S. Cl. CPC A01N 1/0284; A01N 1/0273

(57) ABSTRACT

Methods and devices are provided for executing temperature-controlled shipment of relatively small temperature-sensitive payloads. A vacuum shipper may include a vacuum container and a PCM pack with an outer wall broadly form fitting to the vacuum container. The PCM pack includes a payload cavity and may be pre-conditioned at an effective charging temperature for an effective charging time. A temperature-sensitive payload is placed in the payload cavity. An insulated stopper is pressed into a mouth of the vacuum container. The vacuum shipper may then be conveyed by commercial express freight to its destination within an effective endurance time.

### REFERENCE TO RELATED APPLICATION

This application claims the benefit of U.S. Provisional Patent Application No. 63/353,299, filed on Jun. 17, 2022, and entitled METHODS AND DEVICES FOR THERMAL STABILIZATION OF PERISHABLE BIOLOGICAL SPECIMENS, the content of which is hereby incorporated by reference in its entirety.

### FIELD OF THE INVENTION

This application relates to transport systems and methods for perishable and temperature-sensitive materials including biological specimens such as, but not limited to, whole blood.

### BACKGROUND

Biological samples such as but not limited to blood often need to be maintained within a particular temperature range to ensure quality of the biological sample and any analysis or diagnostic testing performed on such samples. When a temperature range is not maintained, the composition of the sample may change and thereby compromise the accuracy of the test results. As examples, temperatures that are too low may result in damage to enveloped materials (such as cells) due to formation of intracellular ice or may result in the formation of particulate matter due to aggregation of proteins and other dissolved substances. Conversely, elevated temperatures may accelerate degradation of proteins and enveloped materials due to faster chemical reactions at higher temperatures.

The temperature of the biological sample may be controlled in a lab or other similar setting. However, at-home or other remote diagnostic testing may involve a person collecting the biological sample in a location remote from where the analysis is performed (e.g., in their home), and the sample must be shipped to the testing facility. During the shipping process, packages containing biological samples may be subjected to a wide range of temperatures and/or shifting temperatures, causing similar shifts in temperatures in the packages and any biological samples within such packages, thereby affecting the quality of the biological samples. As an example, the cargo areas of trucks may rise up to 60° C. or fall below −20° C., causing similar shifts in temperature in packages contained within.

Applications where a relatively small and low value payload comprising perishable material must be shipped are not well served by typical temperature controlled packaging systems. Small packaging systems using expanded polystyrene and cold packs do not have adequate performance to protect payloads from high or low temperature excursions for multi-day shipping, do not adequately protect specimens, and are not cost-effective for low value payloads such as blood samples for routine diagnostic testing. Thicker insulation results in a higher performance temperature controlled packaging system at a cost of increased weight and size, which in turn increases freight costs based on shipping speed and the combination of package weight and size.

### SUMMARY

Methods and devices for executing temperature-controlled shipment of relatively small temperature-sensitive payloads using mass produced vacuum bottles are disclosed. Briefly, a vacuum shipper comprises a vacuum bottle, one or more PCM packs with an outer wall broadly form fitting to the vacuum bottle. The PCM pack further comprises a payload cavity such that the PCM pack serves both as a sink for heat energy and as a secondary interior layer of insulation. The PCM pack may be pre-conditioned at an effective charging temperature for an effective charging time. In some cases, the PCM pack may be cylindrical. The PCM pack may optionally include two or more sub-packs, each containing a different PCM type. The pre-conditioned PCM pack is placed into a vacuum bottle and a temperature-sensitive payload is placed in the payload cavity. An insulated stopper is pressed into a mouth of the vacuum bottle. The insulated stopper may comprise a handle, a first plug with diameter approximately equal to an inner diameter of the vacuum bottle, and a second plug with diameter approximately equal to a diameter of the payload cavity. The vacuum shipper may then be conveyed by commercial express freight to its destination within an effective endurance time.

Various implementations described herein may include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 is a sectional view of a temperature-controlled packaging system according to embodiments.

FIG. 2 is a sectional view of another temperature-controlled packaging system according to embodiments.

FIG. 3 is a sectional view of another temperature-controlled packaging system according to embodiments.

FIG. 4 includes sectional views of another temperature-controlled packaging system according to embodiments.

FIG. 5 illustrates a disassembled temperature-controlled packaging system according to embodiments.

FIG. 6 illustrates a disassembled temperature-controlled packaging system according to embodiments.

FIG. 7 illustrates assembled and disassembled temperature-controlled packing systems according to embodiments.

FIG. 8 illustrates summer and winter performance of two sub-pack embodiment of a temperature-controlled packaging system according to embodiments.

FIG. 9 illustrates summer and winter performance of two sub-pack embodiment of a temperature-controlled packaging system according to embodiments.

FIG. 10 illustrates long-term summer performance in summer optimized embodiment of a temperature-controlled packaging system according to embodiments.

FIG. 11 illustrates a kit configuration including a temperature-controlled packaging system according to embodiments.

FIG. 12 illustrates a collection and shipping workflow according to embodiments.

### BRIEF DESCRIPTION

Inventions described herein relate to transport of perishable and temperature-sensitive materials including biological specimens. One such biological specimen is whole blood. Transport may be conducted in order to enable laboratory analysis such as diagnostic testing. For example, a biological specimen may be collected from a human or animal at a collection site, and then transported to a centralized laboratory for diagnostic testing. The inventions may also be applied to transport of perishable and temperature-sensitive materials such as food, chemicals, or vaccines.

Diagnostic testing may be conducted on biological samples such as blood. In order to maintain quality of the biological sample for diagnostic testing and/or other analysis, biological samples such as blood and serum may be stored or otherwise kept a temperature range under for a period of time. Different samples may be kept at different temperature ranges, when used for different types of analysis. For example, serum may be stored at a temperature range of 8-32° C. for a period of time of up to 48 hrs. for valid analysis of a particular analyte. Alternately, serum may be stored at a temperature range of about 2-8° C. for a period of time of up to 7 days. Alternately, serum may be frozen at a temperature of about −20° C. or lower for a period of time of up to 1 month. Whole blood may be stored at a temperature range of about 2-8° C., but only for 24 hrs. and it cannot be frozen. When a temperature range is not maintained, the sample's composition may change, particularly the composition of the liquid fraction may change thus giving inaccurate test results.

Temperature regulated packaging systems designed to address this challenge may include one or more phase change materials (PCMs) within an insulated container. PCMs such as water/ice, water/vapor, dry ice, hydrated salts, paraffin waxes, and biological oils, among other examples, may provide cooling and/or heating energy by the release or absorption of the thermal heat of fusion (or vaporization) as appropriate near the temperature of the melting point or evaporation point of the PCM. PCMs may provide a thermal reserve against temperature change far greater than passive materials relying solely on the thermal heat capacity. PCMs may require active refrigeration or heating to achieve the desired material phase state at the initial condition. For instance, a PCM may require freezing by conventional refrigeration prior to its use in thermal regulation of packaged materials. Since they may transition between liquid, solid, or gas phases PCMs may be encapsulated within pouches or other secondary containers.

In a temperature controlled packaging system, an insulated container encloses one or more PCMs along with a payload (e.g., a biological sample, a perishable material, etc.). The insulated container may comprise an insulating material such as expanded polystyrene, polyurethane foam, films containing air pockets, or vacuum insulation. A key parameter in the design of temperature controlled packaging systems is the thermal resistance of the insulating material per unit thickness. Higher thermal resistance or thicker insulation enables reduced volume of PCM and/or greater protection time to enable longer transit time for the payload.

Optimal design for temperature controlled packaging system requires balancing freight cost with the safety of the payload. In certain embodiments, the packaging system is configured to maintain the payload within a target temperature range when challenged by a target maximum thermal load for a specified time period.

The thermal load may be expressed as a temperature differential to be maintained between the exterior of the packaging system and the payload. As a non-limiting example, the thermal load may be expressed as the difference between an external temperature of 30° C. and an internal target temperature of not more than 8° C. (a 22° C. differential).

A total performance metric for the packaging system may be expressed as the product of thermal load and specified time period. As a non-limiting example, a packaging system may be designed to maintain a 22° C. differential for 48 hrs. The packaging systems described herein provide a balance between a smaller and lower performance packaging system that must be shipped at costly express or overnight air rates, and a larger and higher performance packaging system that may be shipped at slower and more economical rates. A compact packaging system with adequate performance for slower shipping speed may be provided to make shipment of high value payloads cost-effective.

### DETAILED DESCRIPTION

Described herein are systems, methods, and devices providing temperature controlled shipment of relatively small temperature-sensitive payloads using vacuum insulated container (e.g., such as a vacuum bottle). The inventions may be particularly useful when applied to shipment of relatively low value payloads that require a simplified operational workflow. As a non-limiting example, disclosed embodiments may be used to protect shipments of self-collected blood samples for diagnostic testing. In some embodiments, a temperature-controlled packaging system includes a container and one or more PCM packs (i) form-fit to the container and (ii) defining a payload cavity for a payload such as but not limited to a biological sample. The PCM pack may serve as both a sink for heat energy and a secondary interior layer of insulation. In certain embodiments, the PCM pack is pre-conditioned at an effective charging temperature for an effective charging time. In various embodiments, the PCM pack includes a first portion and a second portion where the first portion includes a first type of PCM, and the second portion includes a second type of PCM different from the first type of PCM. Optionally, the system includes an insulated stopper with at least a first plug and optionally a second plug.

A basic method involves conditioning a structured PCM pack within a defined temperature range, placing the structured PCM pack and the payload into a matching commercial vacuum bottle of the type commonly used to insulate beverages, pressing a fitted insulated stopper into a mouth of the vacuum bottle that secures the structured PCM pack in place, and shipping the assembly within an effective time period to a destination.

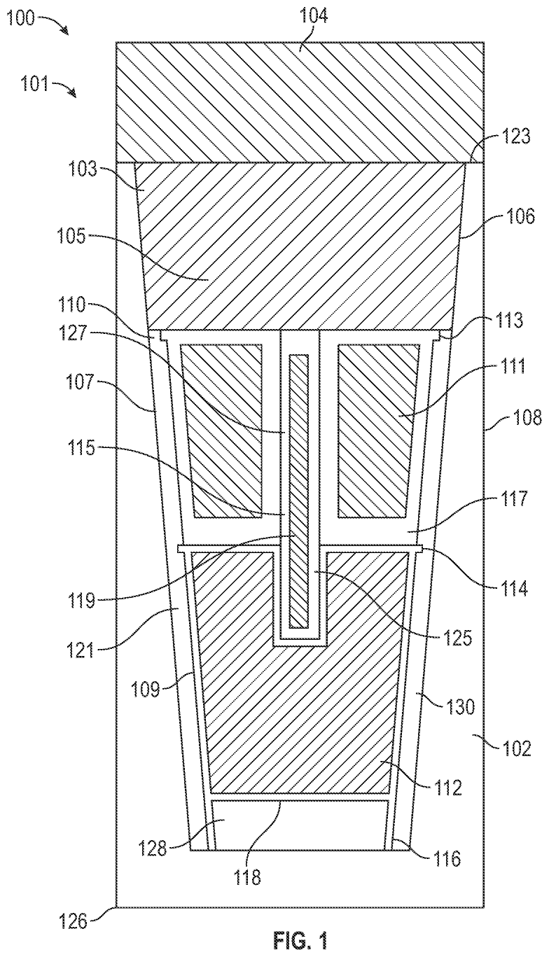

FIG. 1 illustrates a temperature-controlled packaging system 100 according to embodiments. In the embodiment illustrated, the temperature-controlled packaging system 100 is a vacuum shipper 101 that includes a container 102 and one or more PCM packs. In FIG. 1, the temperature-controlled packaging system 100 includes a lower (or first) PCM pack 109 and an upper (or second) PCM pack 110. While two PCM packs are illustrated, in other embodiments, the temperature-controlled packaging system 100 may include a single PCM pack or more than two PCM packs as desired. Optionally, the vacuum shipper 101 includes an insulated stopper 103.

In certain embodiments, the container 102 is a vacuum insulated container, and in one non-limiting embodiment, the container 102 is a vacuum container 102. The container 102 includes an outer wall 108 that extends generally vertical and forms an outer surface of the container 102. The outer wall 108 may have various shapes or profiles as desired. In one non-limiting examples, the outer wall 108 forms an approximately cylindrical outer surface.

In addition to the outer wall 108, the container 102 includes an inner wall 107, and the inner wall 107 defines a receiving area 121 for the container 102. In certain embodiments, a top end 123 of the container 102 defines an opening or mouth providing access to the receiving area 121. As discussed in detail below, the opening may be selectively closed or otherwise sealed or obstructed when the vacuum shipper 101 is to be shipped. Optionally, and as illustrated in FIG. 1, the inner wall 107 may have a taper such that a transverse dimension of the receiving area 121 proximate to the top end 123 is different from a transverse dimension of the receiving area 121 proximate to a bottom end 126 of the container 102. In certain embodiments, and as illustrated in FIG. 1, the transverse dimension of the receiving area 121 proximate to the top end 123 is greater than the transverse dimension of the receiving area 121 proximate to a bottom end 126 of the container 102. In other embodiments, the inner wall 107 may have various tapers as desired. In some embodiments, the taper of the inner wall 107 may be from about 0.5° to about 3° with respect to a vertical axis of the container 102, although in other embodiments the taper may be other angles as desired. In certain embodiments, the container 102 optionally is a vacuum insulated container in which the mouth to the receiving area 121 is not smaller in diameter than a lower portion of the receiving area 121 of the container 102.

The first PCM pack 109 and the second PCM pack 110 are positionable within the receiving area 121 of the container 102. In certain embodiments, the taper of the inner wall 107 may facilitate positioning of the PCM packs 109, 110 within the receiving area 121. In various embodiments, the PCM packs 109, 110 are integrally formed, coupled, and/or otherwise attached to form a single structure, although they need not be in other embodiments.

Referring to FIG. 1, the first PCM pack 109 includes a first PCM 112 within a lower housing 118. In certain embodiments, the lower housing 118 defines a lower portion 125 of a payload cavity 115. Optionally, bottom standoffs 116 extend from the lower housing 118, and when included, the bottom standoffs 116 may allow for the formation of an air gap 128 between a bottom of the lower housing 118 and a bottom of the inner wall 107. When included, such an air gap 128 may provide additional insulation within the receiving area 121. Optionally, a lower rim 114 projects outward from the lower housing 118 and may contact the vacuum bottle inner wall 107. Contact between the lower rim 114 and the inner wall 107 may position the first PCM pack 109 within the container 102 and may form an air gap 130 between a side of the lower housing 118 and sides of the inner wall 107. Such an air gap 130 may provide additional insulation within the receiving area.

The second PCM pack 110 includes a second PCM 111 within an upper housing 117. In certain embodiments, the second PCM 110 is different from the first PCM 112. As a non-limiting example, the first PCM 112 may have a melting point higher than the second PCM 111 such that heat penetrating through the mouth or opening to the receiving area 121 (e.g., through the insulated stopper 103) is first absorbed by the second PCM, which is therefore preferentially melted under hot conditions or frozen under cold conditions. This configuration may be advantageous for maximizing payload protection under cold external conditions. Conversely, in another non-limiting example, the first PCM 112 may have a melting point lower than the second PCM 111 to provide a different temperature control profile. This configuration tends to reduce the temperature gradient under hot external conditions, and thereby may be advantageous for maximizing payload production under hot external conditions. For example, a second PCM with a peak melting temperature of about 18° C. and a broad melting temperature range of 10° C. to 25° C. may be paired with a first PCM with a peak melting temperature of about 14° C. and a broad melting temperature range of 8° C. to 20° C. to prevent a payload from exceeding about 20° C. for 72 hours under hot summer conditions.

Similar to the first PCM pack 109, the second PCM pack 110 optionally includes an upper rim 113 extending outwards from the upper housing 117. As illustrated in FIG. 1, the upper housing 117 may define a second portion 127 of the payload cavity 115. Optionally, the second PCM pack 110 may have an annular shape with a central cavity forming the second portion 127 of the payload cavity 115.

The insulated stopper 103 is configured to close or otherwise obstruct the mouth of the receiving area 121 when the insulated stopper 103 is assembled with the container 102. Optionally, the insulated stopper 103 seals the receiving area 121 when assembled with the container 102. As illustrated in FIG. 1, the insulated stopper 103 includes a plug 105 with a sidewall 106 that may match the diameter and/or the taper of the vacuum bottle inner wall 107. The plug 105 and a mouth of the container 102 may form a friction fit such that the insulated stopper 103 is retained within the mouth of the container 102. In certain embodiments, the insulated stopper 103 optionally includes a handle 104 facilitating handling of the vacuum shipper 101. The handle 104 optionally has an outer diameter that may be approximately equal to an outer diameter of the container 102. In such embodiments, the handle 104 may serve as a stop and indicate when the insulated stopper 103 is properly positioned in the container 102. In other embodiments, the handle 104 may include other diameters and/or shapes as desired.

As illustrated in FIG. 1, the second PCM pack 110, the first PCM pack 109, and optionally a portion of the stopper 103 together form walls of the payload cavity 115 into which a perishable payload 119 may be placed. A temperature of the payload cavity may be influenced by phase change of both the first PCM 112 and second PCM 111. In certain aspects, the temperature of the payload cavity 115 may tend to be intermediate between the melting temperature of the first PCM and second PCM. One or more PCMs within the vacuum shipper may alternately have a phase transition over a broad temperature range. For example, one PCM may gradually transition from liquid to solid at a temperature from about 8° C. to about 18° C. When using a vacuum shipper to protect the payload from both high and low external temperatures, a PCM with phase transition over a broad temperature range may be advantageous. In other embodiments where a single PCM pack is utilized, the PCM pack may achieve bi-directional thermal control using a PCM with a broad phase transition temperature range. In certain embodiments, the transition temperature range may be within a desired effective mean kinetic temperature range, and an incubation temperature may be within the phase transition temperature range. As one non-limiting example, a single PCM may have a melting temperature of about 37° C. and an incubation temperature range of about 37° C. to about 60° C. As mentioned, in other embodiments, other configurations and/or types of PCM packs with one or more types of PCM material may be utilized as desired.

The second PCM pack 110, first PCM pack 109, and payload 119 may be restrained in place and prevented from movement during shipping by the stopper 103. In some embodiments, the stopper plug 105 may contact a top of the second PCM pack 110 to prevent and/or minimize relative movement of the second PCM pack and other items within the vacuum shipper 101.

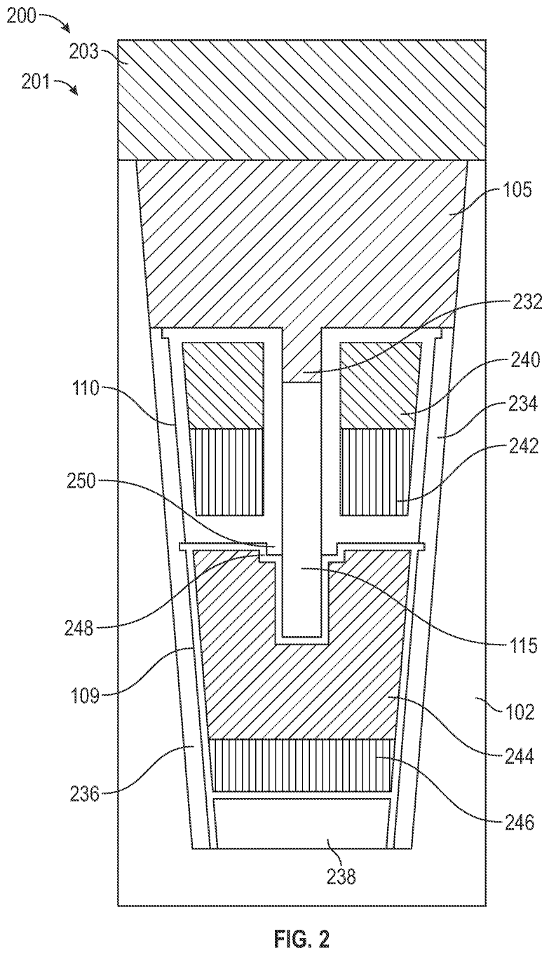

FIG. 2 illustrates another example of a temperature-controlled packaging system 200 according to embodiments. Similar to the temperature-controlled packaging system 100, the temperature-controlled packaging system 200 is a vacuum shipper 201. The vacuum shipper 201 is substantially similar to the vacuum shipper 101 except as discussed below.

In one aspect, compared to the vacuum shipper 101, the vacuum shipper 201 includes an insulated stopper 203 that is substantially similar to the insulated stopper 103 except hat tit additionally includes a second plug 232 extending from the stopper plug 105. In this embodiment and as illustrated in FIG. 2, the second plug 232 may extend partially into the payload cavity 115. In these embodiments, the second plug 232 extending into the payload cavity 115 optionally may cause a portion of the second PCM pack 110 to serve as additional insulation for the payload cavity. The second plug 232 may further contain any sample positioned within the payload cavity 115.

As illustrated in FIG. 2, the second PCM pack 110 and first PCM pack 109 may trap an upper air pocket 234, a lower air pocket 236, and a bottom air pocket 238. When included, these air pockets may serve to provide additional thermal resistance to the payload cavity 115. The air pockets 236 may have various shapes or sizes as desired. In one non-limiting example, the air pockets 236 may have a thickness from about 0.2 mm to about 5 mm.

Compared to the vacuum shipper 101, the second PCM pack 110 and the first PCM pack 109 each include at least two PCMs and/or form at least two PCM phases within the housings 117, 118, respectively. In some embodiments, during the process of melting, a first PCM contained within the second PCM pack 110 may form a first low-density phase 240 and a first high-density phase 242. The first high-density phase 242 may be at a lower or higher temperature than the first low-density phase 240. As a non-limiting example, partially frozen water may form a lower density (ice) phase at 0° C. and a higher density (liquid) phase at 4° C.

In other embodiments, the first low-density phase 240 may represent a distinct PCM that is lower in density than and insoluble in the high-density phase 242. As a non-limiting example, a hydrophobic oil-based PCM may have a lower density than an aqueous water-based PCM and may therefore float on top of the former. As shown, the upper portion 127 of the payload cavity 115 may have a temperature closer to the first higher density phase, which may be advantageous.

Similarly, a second PCM contained within the first PCM pack 109 may form a second lower density phase 244 and a second higher density phase 246, and/or the second lower density phase 244 may be a distinct PCM that is lower in density compared to the second higher density phase 246. As a non-limiting example, a hydrophobic oil based PCM may have a solid fraction that is denser than a (warmer) liquid fraction. As shown, the lower portion 125 of the payload cavity 115 may have a temperature closer to the second lower density phase. Fractionation of PCMs during freezing or melting may therefore be harnessed to moderate the temperature of the payload cavity, particularly if the vacuum shipper apparatus is preferentially shipped upright.

In the embodiment illustrated in FIG. 2, the second PCM pack 110 and the first PCM pack 109 are separate components that are coupled together. In certain embodiments, alignment between the second PCM pack 110 and the first PCM pack 109 may be facilitated by an alignment groove 248 and alignment rib 250. A mating between the alignment groove 248 and the alignment rib 250 may serve to reduce air infiltration into the payload cavity 115, which may further improve the insulating properties.

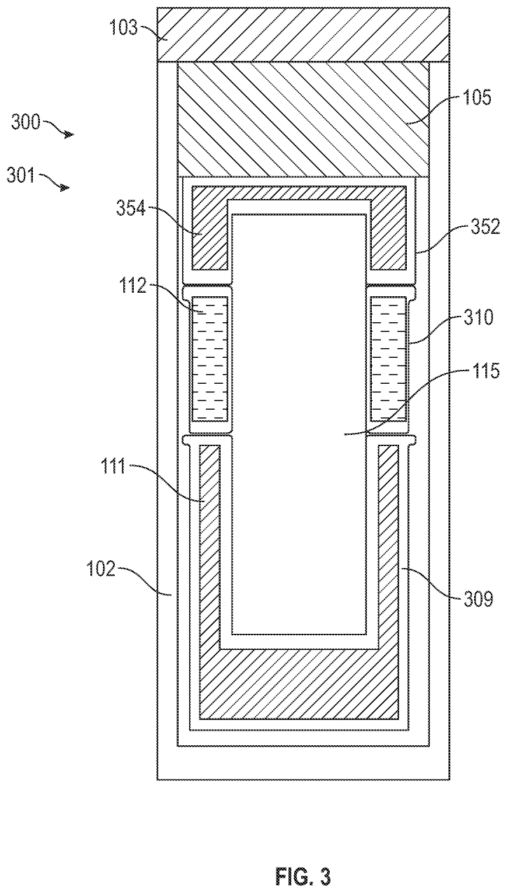

FIG. 3 illustrates another example of a temperature-controlled packaging system 300 according to embodiments. Similar to the temperature-controlled packaging system 100, the temperature-controlled packaging system 300 is a vacuum shipper 301. The vacuum shipper 301 is substantially similar to the vacuum shipper 101 except as discussed below.

Compared to the vacuum shipper 101, the vacuum shipper 301 includes three PCM packs: a first PCM pack 309, the second PCM pack 110, a third PCM pack 352. The first PCM pack 309 is substantially similar to the first PCM pack 109 except that the first PCM pack 309 omits that bottom standoffs 116. The second PCM pack 110 may have an annular shape, although in other embodiments the second PCM pack 110 may have other shapes or profiles as desired. The third PCM pack 352 may be shaped to form an upper barrier between the payload cavity 115 and the stopper plug 105.

In the embodiment illustrated in FIG. 3, the third PCM pack 352 may include a third PCM 354. Optionally, the third PCM 354 is different from at least one of the first PCM 112 and/or the second PCM 111. In some embodiments, the second PCM 111 may have a melting point intermediate between the first PCM 112 and third PCM 354. As a non-limiting example, the first PCM 112 may have a melting point of about 0° C., the second PCM 111 may have a melting point of about 10° C., and the third PCM 354 may have a melting point of about 18° C. In certain embodiments, the payload cavity 115 may be held at a temperature similar to the melting point of the second PCM 111 under both warm and cold exterior conditions.

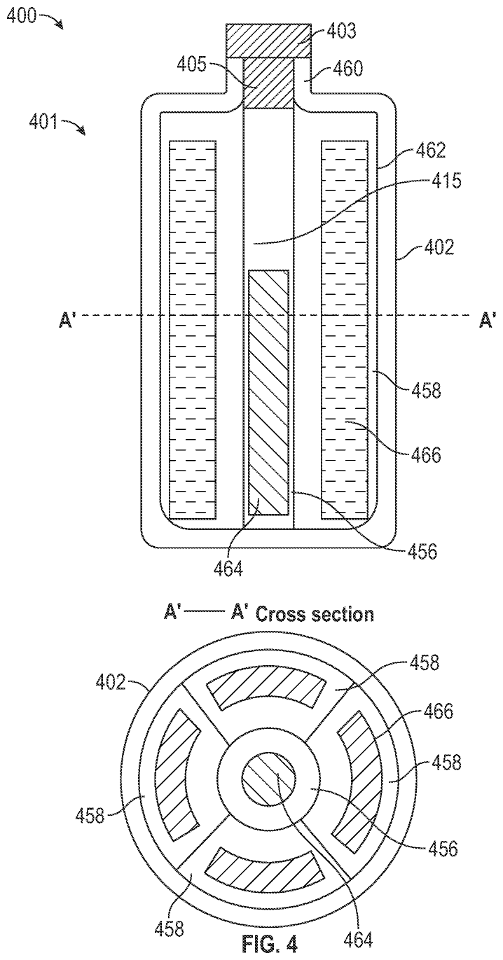

FIG. 4 illustrates another example of a temperature-controlled packaging system 400 according to embodiments. In the embodiment of FIG. 4, the temperature-controlled packaging system 400 includes a vacuum shipper 401 with a narrow-mouth vacuum container 402, an insulated stopper 403, a central PCM pack 456, and peripheral PCM packs 458.

Walls of the central PCM pack 456, peripheral PCM packs 458, and plug 405 of the insulated stopper 403 form a payload cavity 415. The vacuum container 402 includes a mouth 460 and a body section 462. In this embodiment, the mouth 460 has an interior diameter smaller than an interior diameter of the body section 462. As illustrated in FIG. 4, the plug 405 of the stopper 403 may be inserted into the mouth 460 with minimal residual gap.

The central PCM pack 456 may include a central PCM 464 and the peripheral PCM packs 458 may include peripheral PCM 466. The orientations of peripheral PCM packs 458 and central PCM pack 456 are shown in the cross-sectional schematic of FIG. 4. In some embodiments, the central PCM pack 456 is shaped such that it can be removed from the vacuum shipper 401 through the mouth 460. As a non-limiting example, a diameter of the central PCM pack 456 may equal to or smaller than a diameter of the mouth 460. Peripheral PCM packs 458 may also have a diameter smaller than a diameter of the moth to allow insertion into the vacuum shipper 401. Peripheral PCM packs 458 optionally may be permanently attached to the interior of vacuum container 402. In various embodiments, the vacuum shipper 401 may be readied for use by removing the stopper 403, then removing central PCM pack 456 by inverting the vacuum container 402 and dumping it out. Central PCM pack 456 may then be charged by refrigeration for an effective time period, and then placed back into the vacuum container 402. The stopper 403 may then be re-inserted into the vacuum container 402 to facilitate temperature control.

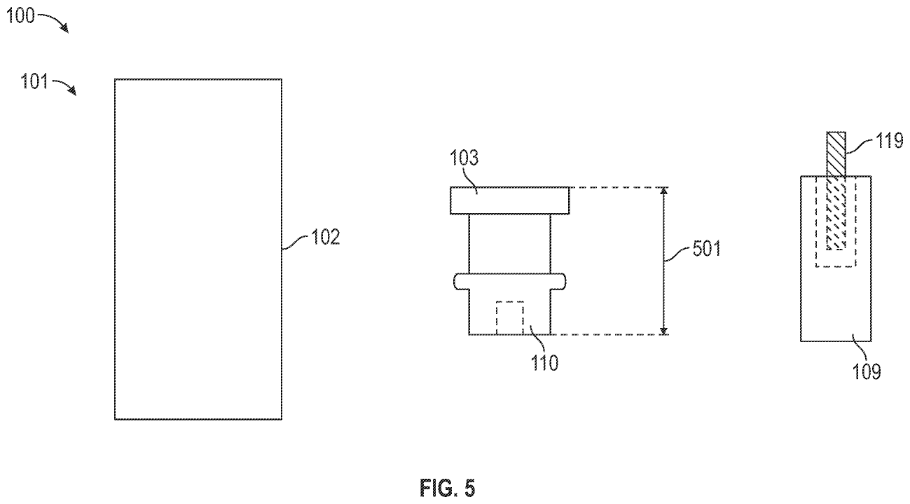

FIG. 5 illustrates a disassembled embodiment of the temperature-controlled packaging system 100 according to embodiments in which the insulated stopper 103 and second PCM pack 110 form an upper assembly 501. In this embodiment, the stopper 103 may be joined (permanently or temporarily) to the second PCM pack 110. Joining the stopper 103 and the second PCM pack 110 may facilitate leaving the upper assembly 501 at ambient temperature while refrigeration of the first PCM pack 109 is being completed. As a non-limiting example, the first PCM pack 109 could be placed in a freezer with temperature of about −20° C. for a 10 hr. period, while the upper assembly 501 is left at room temperature for the same 10 hour period. The payload 119 may then be placed in the lower portion 125 of the payload cavity 115 within lower PCM pack 109 as shown. The first PCM pack 109 may be placed in the container 102 before or after receiving the payload 119. Finally, the assembly 501 may be placed over the payload 119 and into the receiving area 121, thereby sealing the vacuum shipper 101 and initiating temperature control. The payload 119 may then be held at an intermediate temperature between room temperature and the temperature of lower PCM pack 109. For freeze-sensitive materials such as blood, this configuration may prevent over-chilling of the payload 119 by providing a warmer thermal reservoir to balance the initial<0° C. temperature of the first PCM pack 109.

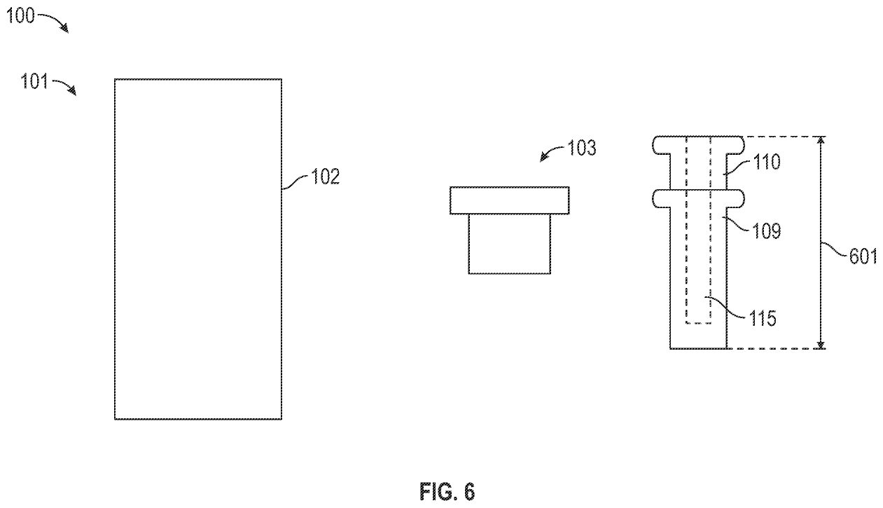

FIG. 6 shows a disassembled embodiment of the temperature-controlled packaging system 100 according to embodiments in which the first PCM pack 109 and the second PCM pack 110 form a lower assembly 601. In this embodiment, the lower assembly 601 includes the second PCM pack 110 permanently or temporarily joined to a first PCM pack 109. The lower assembly 601 includes the payload cavity 115 formed from walls of the first PCM pack 109 and second PCM pack 110. In the embodiment of FIG. 6, the lower assembly 601 may facilitate incubating both the second PCM pack and first PCM pack at the same temperature. As a non-limiting example, lower assembly 601 could be incubated in a commercial refrigerator at around 3° C. for a time period of 10 hrs. This time period could be sufficient to solidify the PCM within the first PCM pack 109 but not the second PCM pack 110. A payload may then be placed in payload cavity 115, and lower assembly 601 could then be placed into container 102. The stopper 103 could then be placed into the container 102 to seal it. Therefore, the lower assembly 601 may be conditioned to resist both high and low external conditions.

Various other sub-assemblies may be formed with the components of the temperature-controlled packaging systems described herein, and the aforementioned examples should not be considered limiting. Moreover, as previously mentioned, the particular arrangement of the PCM packs having different PCMs and/or different PCM phases within the container should not be considered limiting, and in various embodiments the PCM packs may be provided in various arrangements as desired to control a temperature as desired and/or to provide a desired insulation profile.

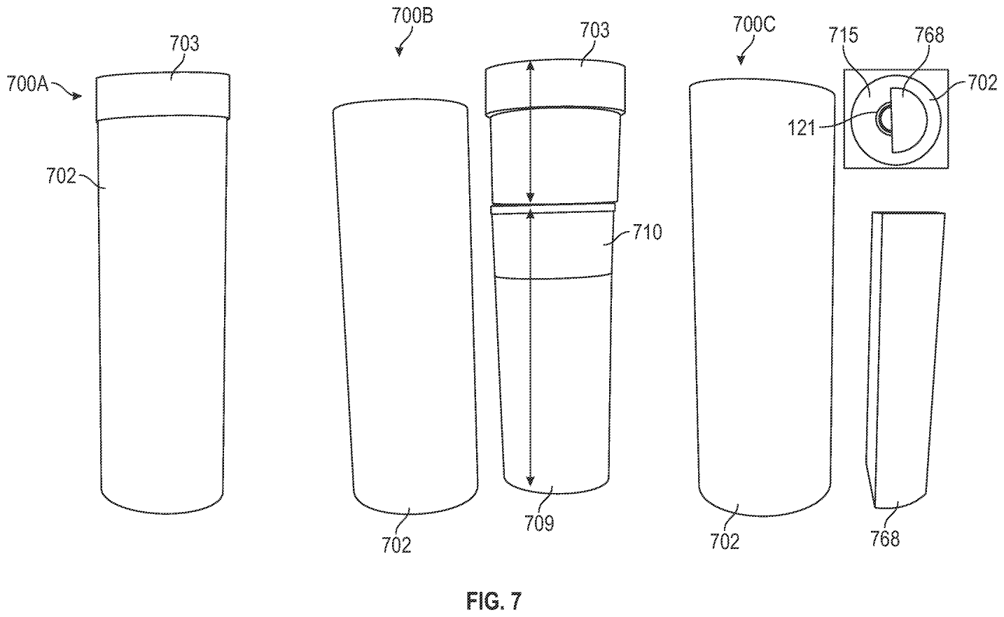

FIG. 7 illustrates another example of an assembled temperature-controlled packaging system 700A, a first disassembled temperature-controlled packaging system 700B, and a second disassembled temperature-controlled packaging system 700C.

Temperature-controlled packaging system 700A is substantially similar to the temperature-controlled packaging system 100 and includes a container 702 and stopper 703.

Temperature-controlled packaging system 700B includes the container 702, the stopper 703, and a PCM assembly 701 including a first PCM pack 709 and a second PCM pack 710. In this embodiment, a payload cavity is defined by the first PCM pack 709 and the second PCM pack 710 similar to the temperature-controlled packaging system 100. In one non-limiting example, the temperature-controlled packaging system 700B may be configured for use with a small blood tube (or any other payload as desired).

Temperature-controlled packaging system 700C include the container 702 and the stopper 703 (not shown). Compared to the temperature-controlled packaging system 700B, the temperature-controlled packaging system 700° C. includes a single PCM pack 768 that forms an along-side payload cavity 715 in the receiving area 121 when inserted into the container 102. In certain embodiments, the PCM pack 768 may have a semi-circular cross-section as illustrated, and in various aspects, the PCM pack 768 may fill more than one-half of the receiving area 121 in a plan view. In such embodiments, the PCM pack 768 occupying more than one half of the receiving area may facilitate positioning of the PCM pack 768 within the receiving area 121.

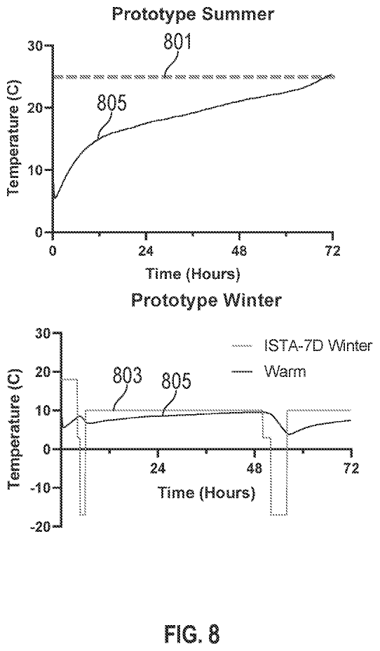

FIG. 8 illustrates internal temperature over time for an embodiment of a temperature-controlled packaging system when exposed to warm (30° C. constant) conditions (line 801) or cold (equivalent to ISTA-7D winter standards) conditions (line 803). A 30 oz. capacity vacuum bottle was used as the container for the temperature-controlled packaging system with a 2 in. thick expanded polystyrene insulated stopper. PCM packs were exposed to commercial refrigeration overnight prior to insertion into the vacuum bottle with stopper. In both cases, and as represented by line 805, performance criteria were met, and the temperature was maintained below about 25° C. and above 0° C. Mean kinetic temperature was also maintained below 20° C. for 72 hrs. In this example, water was used as the second PCM and Puretemp 18 blended with mineral oil was used as the first PCM.

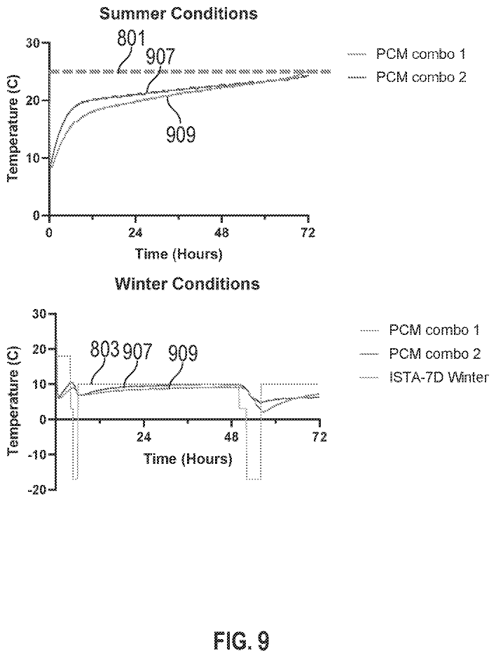

FIG. 9 illustrates internal temperature over time for two embodiments of a temperature-controlled packaging system when exposed to warm (30° C. constant) conditions 801 or cold (equivalent to ISTA-7D winter standards) conditions 803. In this example, 20 oz. capacity vacuum bottles were used as the containers for the temperature-controlled packaging system, and 1 in. thick expanded polystyrene stoppers were used as the insulated stoppers. PCM packs were exposed to commercial refrigeration overnight prior to insertion into the vacuum bottle with stopper. In both external conditions and for both PCM combinations, performance criteria were met, and the temperature was maintained below about 25° C. and above 0° C. Mean kinetic temperature was also maintained below 20° C. for 72 hrs. In this example, water or Templok 5 was used as the second PCM (represented by lines 907) and Puretemp 18 blended with mineral oil or unblended Puretemp 18 was used as the first PCM (represented by lines 909). The combination of vacuum insulation with additional thermal resistance from the PCM elements themselves yielded bi-directional performance results, which were unexpectedly strong given the size of the protective package (about 9 in. by 3 in. in diameter). A conventional expanded polystyrene packaging system of similar size would be expected to endure less than 24 hrs.

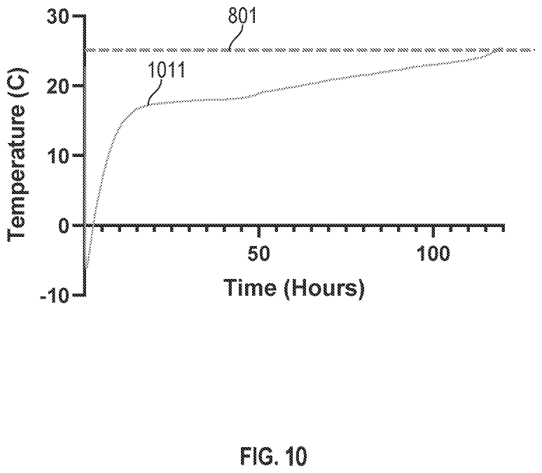

FIG. 10 illustrates internal temperature over time for an embodiment of a temperature-controlled packaging system when exposed to warm (30° C. constant) conditions 803. A 30 oz. capacity vacuum bottle was used as the container for the temperature-controlled packaging system, and a 2 in. thick expanded polystyrene stopper was used as the insulated stopper. PCM packs were exposed to commercial freezing at around −20° C. overnight prior to insertion into the vacuum bottle with stopper, and performance is represented by line 1011. Performance criteria were met, and the temperature was maintained below about 25° C. for 120 hrs. Mean kinetic temperature was also maintained below 20° C. for 120 hrs. In this example, Puretemp 18 was used as both the first PCM and the second PCM.

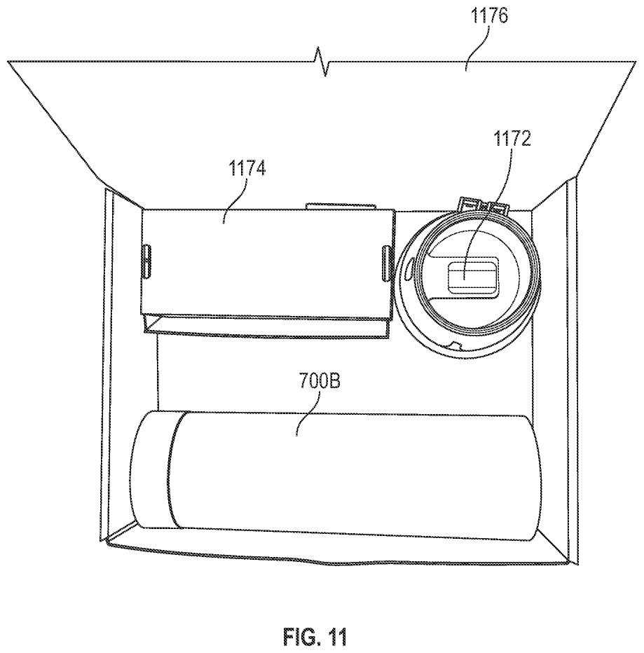

FIG. 11 illustrates a prototype home collection kit layout 1170 including a field-portable centrifuge 1172, the temperature-controlled packaging system 700B (e.g., vacuum shipper), and blood self-collection kit 1174 provided with a shipping container 1176.

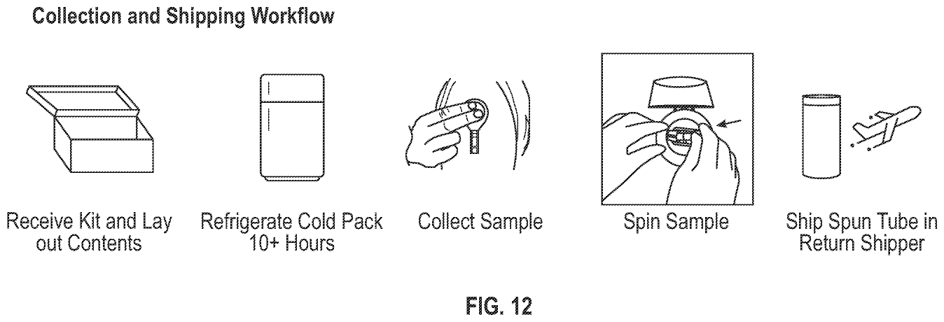

FIG. 12 illustrates a blood sample self-collection, centrifugation, and shipping workflow according to embodiments of the disclosure.

Inventions described herein are particularly applicable to shipment of whole blood specimens or blood derived specimens such as serum or plasma for laboratory testing. For many diagnostic tests, whole blood must be maintained above the freezing point of water (0° C.) and below about 37° C. during shipping to avoid invalid results. For many applications, a lower mean temperature ranges such as from 0-8° C., such as from 2-8° C., such as from 0-15° C., such as from 2-15, such as from 0-20° C., such as from 2-20° C., such as from 0-25° C., and/or such as from 0-25° C. To maintain these temperature ranges under both summer or winter climactic conditions a combination of different PCMs with different melting temperature (or other phase change temperature) ranges may be employed. For example, a PCM with a melting temperature range between −2° C. and 20° C., or preferably between 0° C. and 15° C., may be used in a second PCM pack. A PCM with a melting temperature range between 0° C. and 25° C., or preferably between 5° C. and 20° C., may be used in a first PCM pack. In order to lengthen the tolerable shipping time, in some non-limiting examples, it may be advantageous to employ a PCM with relatively lower melting temperature in the upper position (where heat first infiltrates through the stopper of the vacuum shipper) and to employ a PCM with relatively lower melting temperature in the lower position. Such an orientation of PCMs provides strong cold weather protection during winter, lower initial payload temperature during summer conditions, and longer time duration prior to breaching absolute thermal limits during summer conditions. Due to the larger typical differential between mean summer temperatures and optimal biological storage conditions compared to mean winter conditions in temperate climates, a larger quantity of the first PCM, may be used compared with the upper “antifreeze” PCM. As a non-limiting example, a ratio of between 2:1 and 10:1 between the first PCM and the second PCM may be employed.

An alternate approach to achieving both summer and winter protection optionally may be to use a single PCM with a broad phase change temperature range, conditioned within the range prior to use. As a non-limiting example, a PCM that gradually phase transitions between 0° C. and 20° C. may be pre-refrigerated at a temperature between 2-8° C., resulting in a partially phase changed mixture that can resist both under-temperature and over-temperature. A gradual phase transition may be achieved by blending materials with different melting temperatures such as a blend of olefins or waxes or a blend of salt-hydrates. Alternately, certain salt hydrate blends such as sodium chloride with sodium sulfate decahydrate may inherently possess a broad phase change temperature range.

Payload temperature may be maintained within tolerable temperature limits and/or within an effective mean kinetic temperature range. Effective temperature limits are high or low temperature thresholds beyond with even momentary exposure renders the payload spoiled. As a non-limiting example, even momentary exposure of a blood sample to temperature below −2° C. or above 40° C. may cause invalid laboratory analysis results. The effective mean kinetic temperature range for a given sample will typically be narrower than the tolerable temperature limits and reflects the mean kinetic temperature range that a sample must be maintained within to avoid spoilage within an effective shipping time. Liquid blood, serum, or plasma samples are typically maintained within a temperature range of either about 2° C.-8° C. comparable with commercial refrigeration or between 20° C.-25° C. typically regarded as controlled ambient room temperature. However, blood samples at 2° C.-8° C. tend to exhibit elevated hemolysis (i.e., bursting of red blood cells) over time compared to blood samples maintained at 20° C.-25° C. Conversely blood samples held at 20° C.-25° C. show chemical degradation of laboratory analytes at a greater rate than in blood samples held at 2° C.-8° C. For transit times between about 8 hours and 1 week, an atypical temperature range of 9° C.-19° C. may be advantageous for preserving blood quality for general analytical testing. A properly configured vacuum shipper can maintain the temperature range of 9° C.-19° C. for up to 1 week under typical environmental conditions.

A collection of exemplary embodiments is provided below, including at least some explicitly enumerated as an “Illustration” providing additional description of a variety of example embodiments in accordance with the concepts described herein. These illustrations are not meant to be mutually exclusive, exhaustive, or restrictive; and the disclosure not limited to these example illustrations but rather encompasses all possible modifications and variations within the scope of the issued claims and their equivalents.

Illustration 1. A temperature-controlled packaging system for biological samples, the system comprising a container and a PCM pack (i) form-fit to the container and (ii) defining a payload cavity for a biological sample.

Illustration 2. A temperature-controlled packaging system for biological samples, the system comprising a container and a PCM pack, the PCM pack pre-conditioned at an effective charging temperature for an effective charging time, the PCM pack further defining a payload cavity for a biological sample.

Illustration 3. A temperature-controlled packaging system for biological samples, the system comprising a container and a PCM pack, the PCM pack comprising a first portion and a second portion, the first portion comprising a first type of PCM, the second portion comprising a second type of PCM different from the first type of PCM, the PCM pack defining a payload cavity for a biological sample.

Illustration 4. A temperature-controlled packaging system for biological samples, the system comprising a container, a PCM pack defining a payload cavity, and an insulated stopper comprising a first plug and a second plug.

Illustration 5. A temperature-controlled packaging system for biological samples comprising a vacuum bottle, a cylindrical PCM pack (i) form fitting to the vacuum bottle and (ii) comprising a payload cavity such that the PCM pack serves both as a sink for heat energy and as a secondary interior layer of insulation.

Illustration 6. A method of shipping a biological sample comprising providing a vacuum shipper, positioning a pre-conditioned cylindrical PCM pack into the vacuum shipper, and placing a temperature-sensitive payload in a payload cavity defined by the PCM pack.

Illustration 7. The method of any preceding or subsequent illustration or combination of illustrations, further comprising conveying the vacuum shipper by commercial express freight to its destination within an effective endurance time.

Illustration 8. A temperature-controlled apparatus comprising: a vacuum bottle, an insulated stopper, and a primary PCM pack; wherein the vacuum bottle comprises vacuum insulation, a mouth, an outer wall that is substantially vertical with respect to the mouth, and an inner wall that is tapered inward with respect to vertical at 0-5 degrees; wherein the insulated stopper comprises a handle and a plug that has a friction fit with the mouth; wherein the insulated stopper comprises a thickness of at least 20 mm; wherein the primary PCM pack has a pack outer wall that conforms to the inner wall of the vacuum bottle; wherein a payload cavity of at least 3 cc volume configured to hold a perishable payload is formed from a wall of the primary PCM pack; wherein the payload cavity is at least partially enclosed by the primary PCM pack.

Illustration 9. The apparatus of any preceding or subsequent illustration or combination of illustrations, wherein the primary PCM pack further comprises a rim; wherein the pack outer wall and the rim entraps an air pocket between 0.2 mm and 5 mm thick between itself and the inner wall of the vacuum bottle.

Illustration 10. The apparatus of any preceding or subsequent illustration or combination of illustrations, wherein the payload cavity is centered on a vertical axis of the vacuum bottle.

Illustration 11. The apparatus of any preceding or subsequent illustration or combination of illustrations, wherein the payload cavity is shaped like a vertical cylinder.

Illustration 12. The apparatus of any preceding or subsequent illustration or combination of illustrations, wherein the stopper further comprises a sub-plug centered on the vertical axis of the vacuum bottle with a diameter approximately equal to the payload cavity.

Illustration 13. The apparatus of any preceding or subsequent illustration or combination of illustrations, further comprising a secondary PCM pack; wherein the secondary PCM pack comprises a second phase change material.

Illustration 14. The apparatus of any preceding or subsequent illustration or combination of illustrations, wherein the secondary PCM pack is located vertically above the primary PCM pack; and wherein the payload cavity is further at least partially enclosed by the secondary PCM pack.

Illustration 15. The apparatus of any preceding or subsequent illustration or combination of illustrations, wherein a phase change temperature of the first phase change material is lower than a phase change temperature of the second phase change material.

Illustration 16. The apparatus of any preceding or subsequent illustration or combination of illustrations, wherein a phase change temperature of the second phase change material is in a range of −2° C. to 15° C. and wherein a phase change temperature of the first phase change material is in a range of 5° C. to 25° C.

Illustration 17. The apparatus of any preceding or subsequent illustration or combination of illustrations, wherein a phase change temperature of the second phase change material is in a range of 10° C. to 25° C. and wherein a phase change temperature of the first phase change material is in a range of 8° C. to 20° C.

Illustration 18. The apparatus of any preceding or subsequent illustration or combination of illustrations, wherein a phase transition of the first phase change material occurs over a broad temperature range rather than a precise temperature, and wherein a target temperature range of the payload overlaps with the broad temperature range.

Illustration 19. The apparatus of any preceding or subsequent illustration or combination of illustrations, wherein the first phase change material comprises an inorganic hydrated salt.

Illustration 20. The apparatus of any preceding or subsequent illustration or combination of illustrations, wherein the second phase change material comprises sodium sulfate decahydrate.

Illustration 21. The apparatus of any of any preceding or subsequent illustration or combination of illustrations, wherein the primary PCM pack and the secondary PCM pack are permanently bonded to each other.

Illustration 22. The apparatus of any preceding or subsequent illustration or combination of illustrations, wherein the secondary PCM pack is permanently bonded to the insulated stopper.

Illustration 23. The apparatus of any preceding or subsequent illustration or combination of illustrations, wherein the payload cavity is fully enclosed by the primary PCM pack and secondary PCM pack.

Illustration 24. The apparatus of any of any preceding or subsequent illustration or combination of illustrations, further comprising a tertiary PCM pack; wherein the tertiary PCM pack comprises a third phase change material.

Illustration 25. The apparatus of any preceding or subsequent illustration or combination of illustrations, wherein the apparatus has an overall length of less than 305 mm and a diameter of less than 100 mm.

Illustration 26. The apparatus of any preceding or subsequent illustration or combination of illustrations, wherein the outer wall of the vacuum bottle further comprises printed instructions for use of the apparatus.

Illustration 27. The apparatus of any preceding or subsequent illustration or combination of illustrations, wherein the insulated stopper comprises a single monolithic element of expanded polystyrene, extruded polystyrene, closed cell polyurethane foam, open cell polyurethane foam, or polyisocyanurate foam.

Illustration 28. The apparatus of any preceding or subsequent illustration or combination of illustrations, wherein the insulated stopper comprises a hollow plastic part.

Illustration 29. The apparatus of any preceding or subsequent illustration or combination of illustrations, wherein the insulated stopper further comprises insulating material within the hollow plastic part.

Illustration 30. The apparatus of any preceding or subsequent illustration or combination of illustrations, further comprising a shipping box, wherein the stopper is confined within the vacuum bottle by a structure of the shipping box.

Illustration 31. A method for transporting material using the apparatus of any preceding or subsequent illustration or combination of illustrations, the method comprising the following steps: incubating the primary PCM pack at an effective incubation temperature for an effective incubation time; placing the primary PCM pack into the vacuum bottle; placing a perishable material in the payload cavity; pressing the insulated stopper into the mouth of the vacuum bottle; shipping the apparatus to a destination within an effective shipping time while maintaining a set of tolerable internal temperature limits and an effective mean kinetic temperature range.

Illustration 32. The method of any preceding or subsequent illustration or combination of illustrations, wherein step (a) is achieved by use of a commercial refrigerator and wherein the effective incubation temperature is in a range between 0° C. and 10° C.

Illustration 33. The method of any preceding or subsequent illustration or combination of illustrations, wherein the effective shipping time is in the range of 48 hrs. to 120 hrs.

Illustration 34. The method of any preceding or subsequent illustration or combination of illustrations, wherein the set of effective internal temperature limits is between 0° C. and 25° C.

Illustration 35. The method of any preceding or subsequent illustration or combination of illustrations, wherein the effective mean kinetic temperature range is between 2° C. and 20° C.

Illustration 36. A method for transporting material comprising the following steps: incubating a PCM pack at an effective incubation temperature for an effective incubation time; wherein the PCM pack comprises a first phase change material and a payload cavity; wherein the payload cavity is at least partially enclosed in the PCM pack; placing the PCM pack into a vacuum bottle; wherein the PCM pack further comprises a pack outer wall that conforms to an inner wall of the vacuum bottle; placing a perishable payload in the payload cavity; pressing an insulated stopper into a mouth of the vacuum bottle; wherein the insulated stopper forms a friction fit with the mouth; shipping the assembled vacuum bottle, PCM pack, perishable payload, and insulated stopper to a destination while maintaining a set of tolerable internal temperature limits and an effective mean kinetic temperature range.

Illustration 37. The method of any preceding or subsequent illustration or combination of illustrations, further comprising a step of placing the assembled vacuum bottle, PCM pack, and insulated stopper into a shipper box with an internal length equal to a length of the assembled vacuum bottle, PCM pack, and insulated stopper.

Illustration 38. The method of any preceding or subsequent illustration or combination of illustrations, further comprising a step of placing the perishable payload into a secondary bag.

Illustration 39. The method of any preceding or subsequent illustration or combination of illustrations, further comprising a step of cleaning and disinfecting the vacuum bottle and PCM pack for re-use.

Illustration 40. The method of any preceding or subsequent illustration or combination of illustrations, wherein step (a) is achieved by use of a commercial refrigerator and wherein the effective incubation temperature is in a range between 0° C. and 10° C.

Illustration 41. The method of any preceding or subsequent illustration or combination of illustrations, wherein the effective shipping time is in the range of 8 hrs. to 1 week.

Illustration 42. The method of any preceding or subsequent illustration or combination of illustrations, wherein the effective shipping time is in the range of 48 hrs. to 120 hrs.

Illustration 43. The method of any of any preceding or subsequent illustration or combination of illustrations, wherein the set of effective internal temperature limits is between 0° C. and 25° C.

Illustration 44. The method of any of any preceding or subsequent illustration or combination of illustrations, wherein the effective mean kinetic temperature range is between 2° C. and 20° C.

Illustration 45. The method of any of any preceding or subsequent illustration or combination of illustrations, wherein the effective mean kinetic temperature range is between 9° C. and 19° C.

Illustration 46. The method of any preceding or subsequent illustration or combination of illustrations, wherein the effective mean kinetic temperature range is between 2° C. and 8° C.

Illustration 47. The method of any preceding or subsequent illustration or combination of illustrations, wherein the vacuum bottle has an outer wall that is substantially vertical with respect to the mouth.

Illustration 48. The method of any preceding or subsequent illustration or combination of illustrations, wherein the vacuum bottle has an inner wall that is tapered at an angle from about 0° to about 5° with respect to vertical with respect to the mouth.

Illustration 49. The method of any preceding or subsequent illustration or combination of illustrations, wherein the insulated stopper has a thickness of at least 30 mm.

Illustration 50. The method of any preceding or subsequent illustration or combination of illustrations, wherein the PCM pack further comprises a second phase change material.

Illustration 51. The method of any preceding or subsequent illustration or combination of illustrations, wherein the first phase change material is located below the second phase change material.

Illustration 52. The method of any preceding or subsequent illustration or combination of illustrations, wherein a phase change temperature of the second phase change material is in a range of 10° C. to 25° C. and wherein a phase change temperature of the first phase change material is in a range of 8° C. to 20° C.

Illustration 53. The method of any of any preceding or subsequent illustration or combination of illustrations, wherein the insulated stopper further comprises a stopper PCM, and wherein the insulated stopper is incubated at a second effective incubation temperature during step (a).

Illustration 54. The method of any of any preceding or subsequent illustration or combination of illustrations, wherein the insulated stopper comprises a single monolithic element of expanded polystyrene, extruded polystyrene, closed cell polyurethane foam, open cell polyurethane foam, or polyisocyanurate foam.

Illustration 55. The method of any of any preceding or subsequent illustration or combination of illustrations, wherein the assembled vacuum bottle, PCM pack, perishable payload, and insulated stopper has an overall length of less than 305 mm and a diameter of less than 100 mm.

Illustration 56. The method of any of any preceding or subsequent illustration or combination of illustrations, wherein the assembled vacuum bottle, PCM pack, perishable payload, and insulated stopper has an overall weight of less than 2.5 lbs.

Illustration 57. The method of any of any preceding or subsequent illustration or combination of illustrations, wherein the PCM pack further comprises a rim; wherein an outer wall of the PCM pack and the rim entraps an air pocket between 0.2 mm and 5 mm thick between itself and the inner wall of the vacuum bottle when emplaced.

Illustration 58. The method of any of any preceding or subsequent illustration or combination of illustrations, wherein the perishable payload is blood, serum, or plasma.

Illustration 59. The method of any preceding or subsequent illustration or combination of illustrations, wherein the perishable payload is living cells.

The subject matter of embodiments is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “front,” and “back,” among others, are intended to refer to the orientation as illustrated and described in the figure (or figures) to which the components and directions are referencing. In the figures and the description, like numerals are intended to represent like elements. Throughout this disclosure, a reference numeral with a letter refers to a specific instance of an element and the reference numeral without an accompanying letter refers to the element generically or collectively. Thus, as an example (not shown in the drawings), device “12A” refers to an instance of a device class, which may be referred to collectively as devices “12” and any one of which may be referred to generically as a device “12”. As used herein, the meaning of “a,” “an,” and “the” includes singular and plural references unless the context clearly dictates otherwise.

All ranges disclosed herein are to be understood to encompass any and all subranges subsumed therein. For example, a stated range of “1 to 10” should be considered to include any and all subranges between (and inclusive of) the minimum value of 1 and the maximum value of that is, all subranges beginning with a minimum value of 1 or more, e.g. 1 to 6.1, and ending with a maximum value of 10 or less, e.g., 5.5 to 10.

The above-described aspects are merely possible examples of implementations, merely set forth for a clear understanding of the principles of the present disclosure. Many variations and modifications may be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

That which is claimed:

1. A temperature-controlled packaging system for biological samples, the system comprising a container and a PCM pack (i) form-fit to the container and (ii) defining a payload cavity for a biological sample.

2. The temperature-controlled packaging system of claim 1, wherein the PCM pack is pre-conditioned at an effective charging temperature for an effective charging time.

3. The temperature-controlled packaging system of claim 1, wherein the PCM pack comprises a first portion and a second portion, the first portion comprising a first type of PCM, the second portion comprising a second type of PCM different from the first type of PCM, the PCM pack defining a payload cavity for a biological sample.

4. The temperature-controlled packaging system of claim 1, further comprising an insulated stopper comprising a first plug and a second plug.

5. The temperature-controlled packaging system of claim 1, wherein the PCM pack serves both as a sink for heat energy and as a secondary interior layer of insulation.

6. The temperature-controlled packaging system of claim 1, further comprising an insulated stopper, wherein:
the container comprises a vacuum bottle comprising vacuum insulation, a mouth, an outer wall that is substantially vertical with respect to the mouth, and an inner wall that is tapered inward with respect to vertical at 0-5 degrees;
the insulated stopper comprises a handle and a plug that has a friction fit with the mouth, wherein the insulated stopper comprises a thickness of at least 20 mm;
the PCM pack has a pack outer wall that conforms to the inner wall of the vacuum bottle; and
the payload cavity comprises at least 3 cc volume and is formed from a wall of the PCM pack, and wherein the payload cavity is at least partially enclosed by the PCM pack.

7. The temperature-controlled packaging system of claim 1, wherein the PCM pack further comprises a rim and a pack outer wall, and wherein the pack outer wall and the rim entraps an air pocket between 0.2 mm and 5 mm thick between itself and an inner wall of the container.

8. The temperature-controlled packaging system of claim 1, wherein the payload cavity is centered on a vertical axis of the container.

9. The temperature-controlled packaging system of claim 8, further comprising an insulated stopper, wherein the insulated stopper further comprises a sub-plug centered on the vertical axis of the container with a diameter approximately equal to the payload cavity.

10. The temperature-controlled packaging system of claim 1, wherein the PCM pack is a primary PCM pack comprising a first phase change material, and wherein the temperature-controlled packaging system further comprises a secondary PCM pack, wherein the secondary PCM pack comprises a second phase change material.

11. The temperature-controlled packaging system of claim 10, wherein the secondary PCM pack is located vertically above the primary PCM pack, and wherein the payload cavity is further at least partially enclosed by the secondary PCM pack.

12. The temperature-controlled packaging system of claim 10, wherein a phase change temperature of the first phase change material is lower than a phase change temperature of the second phase change material.

13. The temperature-controlled packaging system of claim 10, wherein a phase change temperature of the second phase change material is in a range of −2° C. to 15° C. and wherein a phase change temperature of the first phase change material is in a range of 5° C. to 25° C.

14. The temperature-controlled packaging system of claim 10, wherein at least one of:
the primary PCM pack and the secondary PCM pack are permanently bonded to each other; or
the secondary PCM pack is permanently bonded to an insulated stopper.

15. The temperature-controlled packaging system of claim 1, wherein:
the container comprises a vacuum bottle, wherein the vacuum bottle comprises vacuum insulation, a mouth, an outer wall that is substantially vertical with respect to the mouth, and an inner wall that is tapered inward with respect to vertical at 0-5 degrees;
the temperature-controlled packaging system further comprises an insulated stopper, wherein the insulated stopper comprises a handle and a plug that has a friction fit with the mouth, wherein the insulated stopper comprises a thickness of at least 20 mm;
the PCM pack comprises a pack outer wall that conforms to the inner wall of the vacuum bottle;
the payload cavity comprises a volume of at least 3 cc and is formed from a wall of the primary PCM pack; and
the payload cavity is at least partially enclosed by the primary PCM pack.

16. A method of shipping a biological sample comprising providing a vacuum shipper, positioning a pre-conditioned cylindrical PCM pack into the vacuum shipper, and placing a temperature-sensitive payload in a payload cavity defined by the PCM pack.

17. The method of claim 16, wherein the PCM pack comprises a primary PCM pack, and wherein the method further comprises:
incubating the primary PCM pack at an effective incubation temperature for an effective incubation time;
placing the primary PCM pack into the vacuum shipper; and
pressing an insulated stopper into the mouth of a vacuum shipper.

18. The method of claim 17, wherein the effective incubation temperature is in a range between 0° C. and 10° C.

19. The method of claim 16, further comprising shipping the apparatus to a destination within an effective shipping time while maintaining a set of tolerable internal temperature limits and an effective mean kinetic temperature range.

20. The method of claim 19, wherein the effective mean kinetic temperature range is between 2° C. and 20° C., and wherein the effective shipping time is in the range of 48 hrs. to 120 hrs.
